(19) United States
(12) Patent Application Publication
(10) Pub. No.: US 2018/0018687 A1
(43) Pub. Date: Jan. 18, 2018

(54) Method of Improving Accuracy of Competitive Pricing Intelligence

(71) Applicant: MyWorld, Inc., Scottsdale, AZ (US)

(72) Inventor: Kenneth J. Ouimet, Davis, CA (US)

(73) Assignee: MyWorld, Inc., Scottsdale, AZ (US)

(21) Appl. No.: 15/648,233

(22) Filed: Jul. 12, 2017

Related U.S. Application Data
(60) Provisional application No. 62/362,507, filed on Jul. 14, 2016.

(51) Int. Cl. G06Q 30/02; G06K 7/10; G06K 7/14

(52) U.S. Cl. CPC G06Q 30/0206; G06Q 30/0208; G06K 7/1413; G06K 2007/10524

(57) ABSTRACT

A method of competitive shopping comprises generating a list of products to be audited at a retailer. The list of products is optimized to minimize price uncertainty. The list of products is transmitted to a mobile device of an auditor. The auditor is prompted to enter a price charged by the retailer for a product from the list of products using the mobile device. An entered price for the product is compared to an expected price range for the product. The expected price range of the product is calculated based on known pricing strategies of the retailer. The entered price is stored in a database if the entered price is within the expected price range. The auditor is prompted to verify the entered price for the product if the entered price is outside of the expected price.

### CLAIM TO DOMESTIC PRIORITY

The present application claims the benefit of U.S. Provisional Application No. 62/362,507, filed Jul. 14, 2016, which application is incorporated herein by reference.

### FIELD OF THE INVENTION

The present invention relates in general to retail revenue management and, more particularly, to a method of improving the accuracy of competitive pricing intelligence.

### BACKGROUND OF THE INVENTION

Economic and financial modeling and planning are commonly used to estimate or predict the performance and outcome of real systems, given specific sets of input data of interest. An economic-based system will have many variables and influences which determine its behavior. A model is a mathematical expression or representation, which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system, which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

Economic modeling has many uses and applications. One area in which modeling has been applied is in the retail environment. Grocery stores, general merchandise stores, specialty shops, and other retail outlets face stiff competition for limited consumers and business. Most, if not all, retail stores expend great effort to maximize sales, revenue, and profit. Economic modeling can be an effective tool in helping storeowners and managers to forecast and optimize business decisions. Economic models are used by retailers to set prices for products being sold. Retail prices need to be set such that a retailer stays competitive with other retailers, but does not over-discount and lose profit unnecessarily.

In order to remain competitive without over-discounting, retailers base prices in large part on competitive pricing intelligence. Auditors that work for a retailer, or for a third party service provider, visit competing retailers and note prices for products of interest. In total, retailers spend over $100 million per year in the United States to collect pricing data of competitors. Most is collected manually by visiting stores. A retailer uses the intelligence data collected by auditors to set prices.

However, collecting accurate intelligence data can be a challenge. Auditors waste significant amounts of time searching a retailer for products the retailer does not sell, increasing the total auditing time and the price to collect the data. Auditors spend time collecting prices for products that are unlikely to have changed prices, and fail to check the price of a product that probably has changed price, reducing the value of the intelligence data to a retailer. Moreover, auditors commonly enter incorrect data inadvertently by noting the price of a wrong product or by mistyping a price, e.g., accidentally transposing digits or hitting a wrong number button. Error rates of 15%-30% are common in the competitive pricing industry.

Inaccurate competitive pricing intelligence results in retailers setting sub-optimal prices on products. Products can be priced lower than required to stay competitive, commonly resulting in a lost profit margin of 20-100 basis points. Products can also be priced too high, resulting in a poor price image with fickle consumers. In any case, poor market intelligence results in a slow tactical competitive response and lost profits. A large grocery retailer is likely to lose around 40-45 basis points due to poor competitive intelligence, so a $13 billion grocery retailer might lose $52 million per year. Smaller specialty retailers have a harder time achieving accurate intelligence data and may be losing as much as 120-125 basis points. A $1.5 billion specialty retailer could lose $15 million per year.

For a typical retailer, the value of an ideal competitive price auditing company (comp shop) is around $66,806 per month. However, poor accuracy and slow response time in comp shops using prior art methods costs the retailer around $52,055 per month, for a gross benefit of only about $14,750. The comp shop typically costs around $8,000 per month, which means the net benefit the retailer sees from using the comp shop is only $6,750. The return-on-investment (ROI) for the retailer is only about 84%, much lower than the theoretical maximum ROI of 835% if the cost of poor accuracy and slow responsiveness could be eliminated. Just increasing the cost of the comp shop to $10,083 while improving intelligence gather to reduce the cost of poor accuracy and slow response to $15,726 increases the ROI of a comp shop to 407%. Retailers want a way to significantly increase the accuracy of competitive pricing data without significantly increasing the cost of collecting the competitive pricing data.

### BRIEF DESCRIPTION OF THE DRAWINGS

FIG. 1 illustrates an exemplary commerce system including a competitive shopping (comp shop) service provider;

FIGS. 2a-2b illustrate an electronic network for the comp shop to interface with employees and clients;

FIG. 3 illustrates logging in to the comp shop;

FIG. 4a-4f illustrate a retailer requesting comp shop missions, and the comp shop splitting up the request into missions; and

FIGS. 5a-5n illustrate an auditor executing a comp shop mission.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

In the face of mounting competition and high expectations from investors, a business must look for every advantage it can muster in maximizing market share and profits. The ability to consider factors which materially affect overall revenue and profitability and adjust the business plan accordingly is vital to the success of the bottom line, and the fundamental need to not only survive but to prosper and grow.

An important aspect of maximizing profits is revenue management. Retailers face important decisions regarding what to sell, when to sell, to whom to sell, and for what price. Retailers use data driven tactics and strategy to answer those questions and increase revenue. Retailers set prices based on consumer behavior models, with competitive pricing data as an input to the models. Consumer behavior models predict purchasing decisions of consumers for products that a retailer sells at various product prices, and retailer management selects a price calculated to maximize revenue.

Competitive price intelligence data is generally gathered by auditors that manually shop at a store's competitors to record the prices of products of interest. Auditors can be employees of a specific retailer, and audit at competing retailers. Auditors also commonly work for a third party, and collect price data at retailers in a geographic area. Retailers contract with the auditing firms and request the auditing firms gather prices for specific products at specific competing retailers. Retailers may also simply purchase bulk data from the auditing firm. Sometimes auditing is done by crowdsourcing. A consumer downloads an auditing app onto a cell phone or other mobile device, and goes on auditing missions to nearby retailers that are assigned by a service provider. Consumers can volunteer, receive monetary compensation, or be rewarded with discounts or otherwise.

Optimal revenue management strategies require input data that is as up-to-date and accurate as possible. When accurate information about competing retailers' prices is input into the models, the models give predictions that are more useful and are more likely to be trusted by the retailers. Gathering accurate results requires auditing the products that are most likely to have changed price to minimize uncertainty in the available price data. In addition, gathered prices are checked against predictive models in real time to check for clearly erroneous entries.

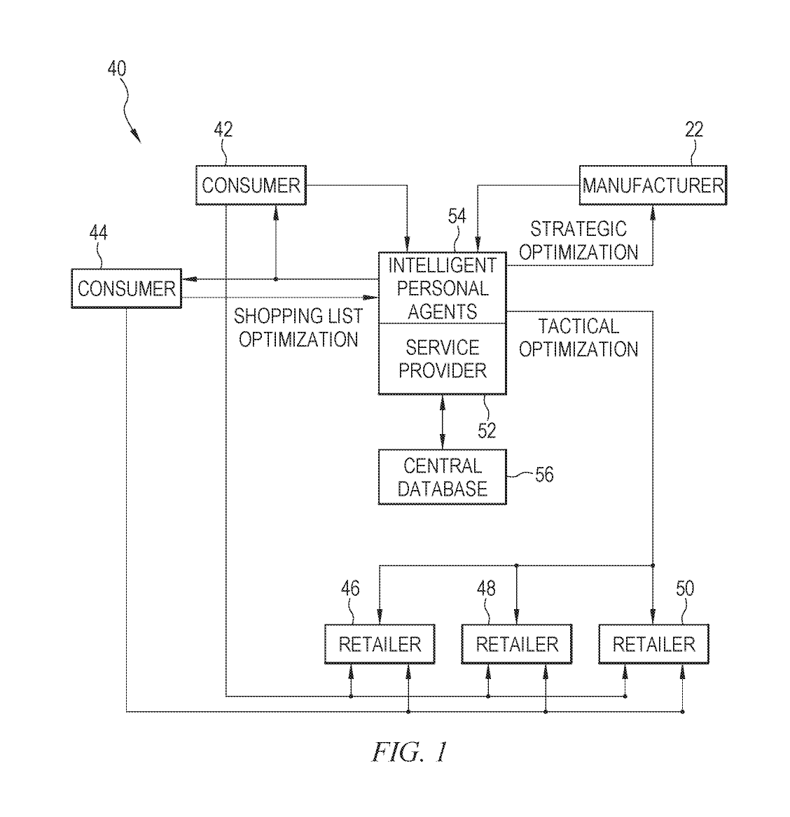

FIG. 1 shows an exemplary commerce system 40 with consumers 42-44 engaged in purchasing transactions with retailers 46-50. Manufacturers 22 and distributors supply products to retailers 46-50 for sale to consumers 42-44. Retailers 46-50 are typically local to consumers 42-44, i.e., retailers that consumers 42-44 are likely to patronize in person. Retailers 46-50 can also be remote from consumers 42-44 with transactions handled using electronic communication medium, e.g., ordering by telephone or online via a personal computer or mobile device. Consumers 42-44 patronize retailers 46-50 by selecting one or more products for purchase from one or more retailers 46-50. For example, consumer 42 visits the store of retailer 46 in person and picks up products to purchase from a display shelf. Consumers 42-44 and retailers 46-50 regularly engage in commercial transactions within commerce system 40.

As described herein, manufacturer 22, retailers 46-50, and consumers 42-44 are members of commerce operating within commerce system 40. The retailer generally refers to the seller of a product, and the consumer generally refers to the buyer of the product.

A service provider 52 is a part of commerce system 40. Service provider 52 is a third party that assists consumers 42-44 with the product evaluation and purchasing decision process by providing access to a comparative shopping service and one-to-one negotiation with manufacturers and retailers. More specifically, service provider 52 generates, operates, and maintains an intelligent personal agent 54 for each member of commerce utilizing the service provider. The intelligent personal agents 54 evaluate product attributes and optimize product selection according to consumer-weighted preferences.

Intelligent personal agents 54 are computerized agents giving consumers the benefit of access to data stored in central database 56 of service provider 52, which is otherwise unavailable to the consumers. Intelligent personal agents 54 maximize value for consumers 42-44 when spending a grocery budget by using the product attributes and consumer-weighted preferences stored in central database 56. Intelligent personal agents 54 identify intent to buy of consumers 42-44 and utilize the intent to buy in negotiating offers on behalf of consumers. Service provider 52 also provides intelligent personal agents for retailers 46-50 which are capable of negotiating with intelligent personal agents provided for consumers in machine-to-machine commerce.

Service provider 52 can provide different services to different members of commerce. Service provider 52 can be used to gather and analyze market intelligence for retailers 46-50, then use the intelligence to help retailers set prices, design and execute marketing campaigns, and optimize inventory.

Central database 56 includes store, product, and pricing information collected by or submitted to service provider 52. Central database 56 includes data generated by consumers, manufacturers, and retailers. Central database 56 also houses data collected by auditors working for retailers 46-50 or service provider 52. Central database 56 includes store name, location, and hours for retail stores in the service area of service provider 52. In one embodiment, central database 56 includes information on 20,000 or more retail locations across the United States. Central database 56 includes detailed information on over 3 million products available for purchase at the cataloged stores, including separate categories for the products, attributes of the products, and relationships between the millions of products.

Central database 56 includes separate prices for in-store or online purchases, as well as regular prices, loyalty prices, and promotional prices, which adds up to over 10-20 million total prices stored in the central database. Service provider 52 includes category management algorithms and tools that structure and organize the store, product, and price information into central database 56. In some embodiments, central database 56 is implemented as multiple databases spread across multiple computer systems, each accessible by an application programming interface (API).

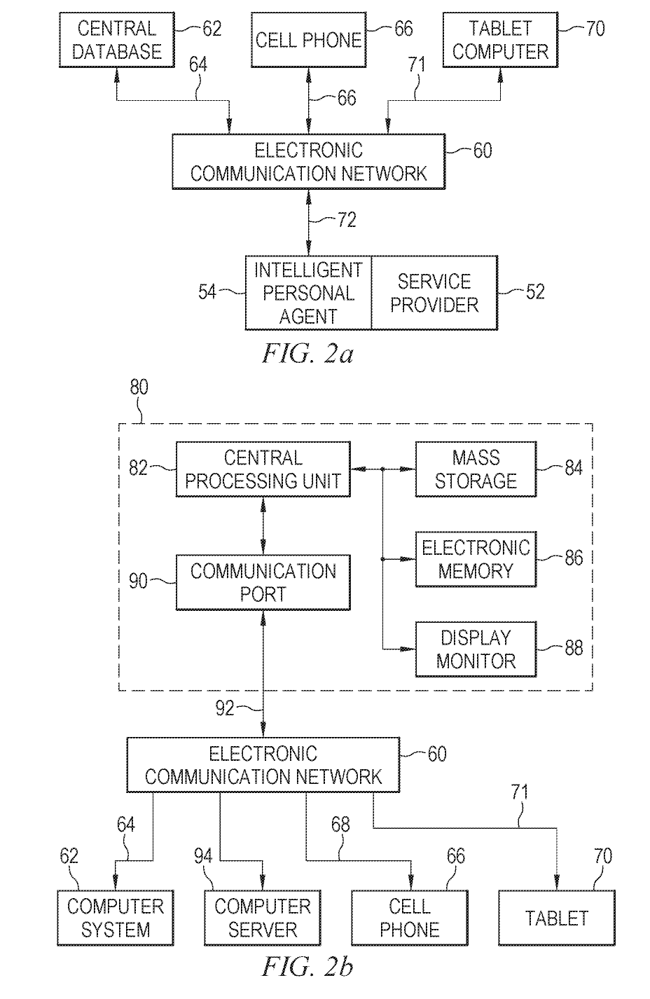

Service provider 52, including intelligent personal agents 54, is available to consumers 42-44, manufacturer 22, and retailers 46-50 via a computer-based online website or other electronic communication medium, e.g., wireless cell phone, tablet, or other personal communication device. FIG. 2a shows an electronic communication network 60 for transmitting information between consumer 42, service provider 52, and retailers 46-50. Any member of commerce operates computer system 62, cell phone 66, or tablet computer 70 to access service provider 52. Computer 62 is connected to electronic communication network 60 by way of communication channel or link 64. Likewise, cellular telephone or smartphone 66 connects to electronic communication network 60 via communication link 68 and tablet 70 is connected to electronic communication network 60 by way of communication channel or link 71.

Service provider 52 communicates with electronic communication network 60 over communication channel or link 72. Generally, members of commerce connect to service provider 52 via an intelligent personal agent 54 created specifically for the member of commerce. Intelligent personal agents 54 include an API providing access to data and features of the intelligent personal agents and service provider. Devices and applications used by members of commerce connect to the API of a respective intelligent personal agent over electronic communication network 60.

The electronic communication network 60 is a distributed network of interconnected routers, gateways, switches, and servers, each with a unique internet protocol (IP) address to enable communication between individual computers, cellular telephones, tablets, electronic devices, or nodes within the network. In one embodiment, electronic communication network 60 includes a cell phone service network. In other embodiments, communication network 60 is a global, open-architecture network, commonly known as the internet.

Communication channels 64, 68, 71, and 72 are bi-directional and transmit data between computer 62, cell phone 66, tablet 70, service provider 52, and electronic communication network 60 in a hard-wired or wireless configuration. For example, computer 62 has email, and web browsing capability, and consumer cell phone 66 and tablet 70 have email, mobile applications (apps), texting, and web browsing capability.

Further detail of the computer systems used in electronic communication network 60 is shown in FIG. 2b as a simplified computer system 80 for executing software programs used in the electronic communication process. Computer system 80 is a general-purpose computer including a central processing unit (CPU) or microprocessor 82, mass storage device or hard disk 84, electronic memory or RAM 86, display monitor 88, and communication port 90. Communication port 90 represents a modem, high-speed Ethernet link, wireless, or other electronic connection to transmit and receive data over communication link 92 to electronic communication network 60. Computer system 62 and server 94 are configured similar to, and include similar internal parts as, computer 80. Cell phone 66 and tablet 70 include similar components and operate similarly to computer system 80, although commonly run different operating systems, software, and include smaller parts and packaging. Computer systems 62 and 80, server 94, cell phone 66, and tablet 70 transmit and receive information and data over communication network 60.

Computer systems 62, 80, and 94 are physically located in any location with access to a modem or communication link to network 60. For example, computer systems 62, 80, and 94 are located in a home or business office, an office of service provider 52, or are mobile and accompany the user to any convenient location, e.g., remote offices, consumer locations, hotel rooms, residences, vehicles, public places, or other locales with wired or wireless access to electronic communication network 60. Consumer 42 also accesses service provider 52 by mobile apps operating on cell phone 66 or tablet 70, which are carried on the person of consumer 42.

Each of the computers 62, 80, and 94 runs application software and computer programs, which are used to display user interface screens, execute the functionality, and provide the electronic communication features as described herein. The application software includes an internet browser, local email application, mobile apps, word processor, spreadsheet, and the like. In one embodiment, the screens and functionality come from the application software, i.e., the electronic communication runs directly on computer systems 62, 80, and 94. Alternatively, the screens and functions are provided remotely from one or more websites on servers connected to electronic communication network 60.

The software is originally provided on computer readable media, such as compact disks (CDs), digital versatile disks (DVDs), flash drives, and other optical media or mass storage medium. Alternatively, the software is downloaded electronically, such as from a host or vendor website. The software is installed onto the computer system hard drive 84 and/or electronic memory 86, and is accessed and controlled by the computer operating system. Software updates are also available on mass storage medium or downloadable from the host or vendor website. The software, as provided on the computer readable media or downloaded from electronic links, represents a computer program product containing computer readable program code embodied in a non-transitory computer program medium. Computer systems 62, 80, and 94 execute instructions of the application software for communication between consumers 42-44 and service provider 52 to generate shopping lists, accommodate one-to-one negotiation, and make product recommendations. Cell phone 66 or tablet 70 runs one or more mobile apps to execute instructions for communication between consumers 42-44 and service provider 52 which generate shopping lists and make recommendations for consumers 42-44. The application software is an integral part of the control of commercial activity within commerce system 40.

One important function that service provider 52 helps retailers with is setting prices. As discussed above, retailers 46-50 use various pricing strategies in an attempt to increase profitability. No matter what pricing strategy a retailer decides to use, prices of relevant competitors is an important input into the price-setting decision. Service provider 52 is used by retailers to gather competitive pricing intelligence, i.e., to get insight into the prices that competitors have set for products similar to what the retailer sells.

Service provider 52 allows a retailer log in and use a mission control website of the service provider to subscribe to audits of products at competitive retailers. A retailer logs in and enters a list of products to audit and a list of stores to audit those products at. Service provider 52 splits the workload into a plurality of missions. Each mission is a list of products for an auditor to shop in one auditing trip. Each mission can be for one or more retail locations, and can include from only a handful of products or less to hundreds of products or more. To complete a mission, an auditor starts an app on his or her phone that directs the auditor to a retailer. The app displays products for the auditor to price check, and the auditor enters available prices for the product.

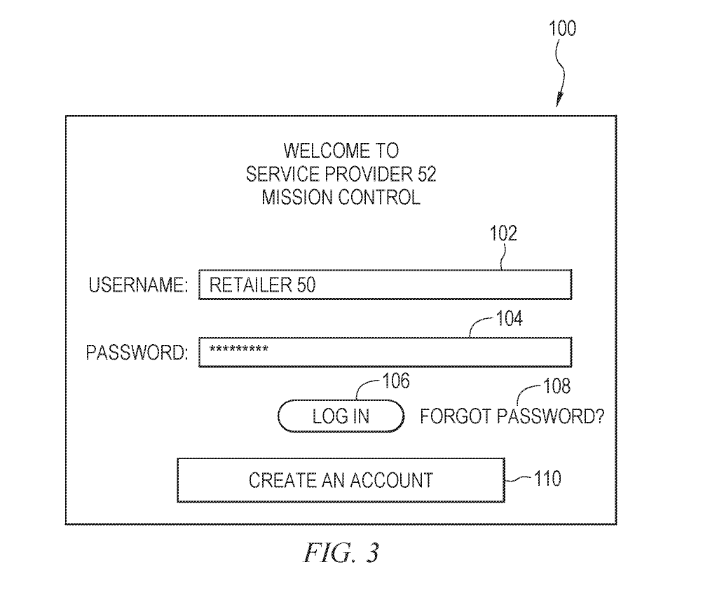

In FIG. 3, a manager or other representative of retailer 50 logs into a mission control website 100 run by service provider 52. Mission control website 100 allows any retailer to set up subscriptions, or make requests, for gathering of pricing intelligence data of specific products at specific competitors. Retailer 50 logs in by typing a user name associated with the retailer, or an employee of the retailer, into username field 102 and a password associated with the specific user into password field 104. A user who has forgotten his or her password may click forgot password prompt 108 to recover account information. A new user can click create an account prompt 110 to set up a new account and access the functionality of service provider 52.

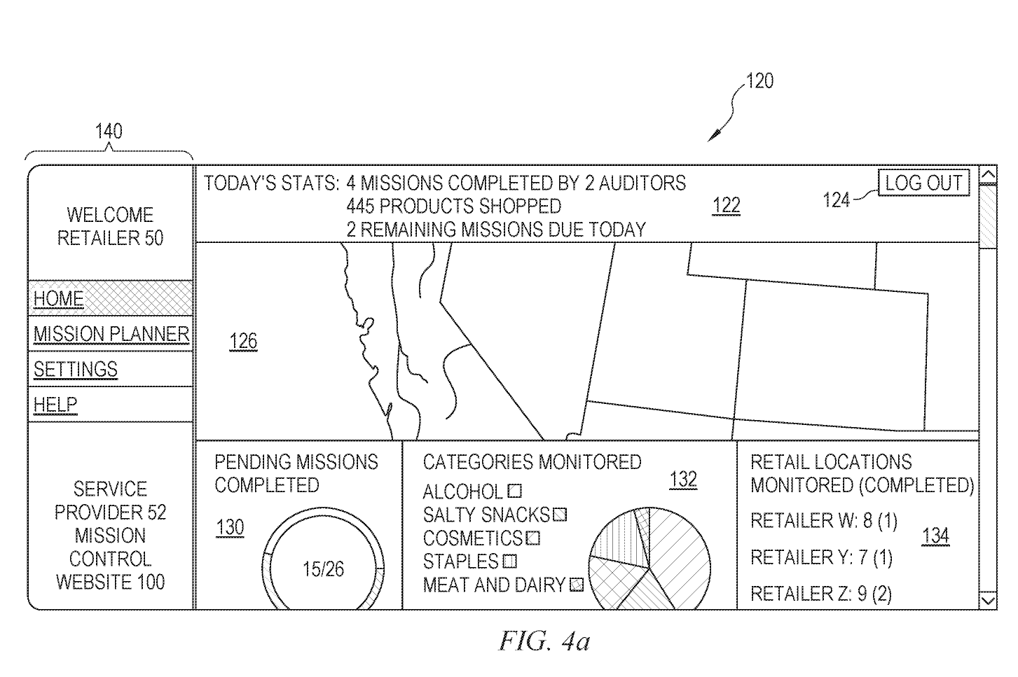

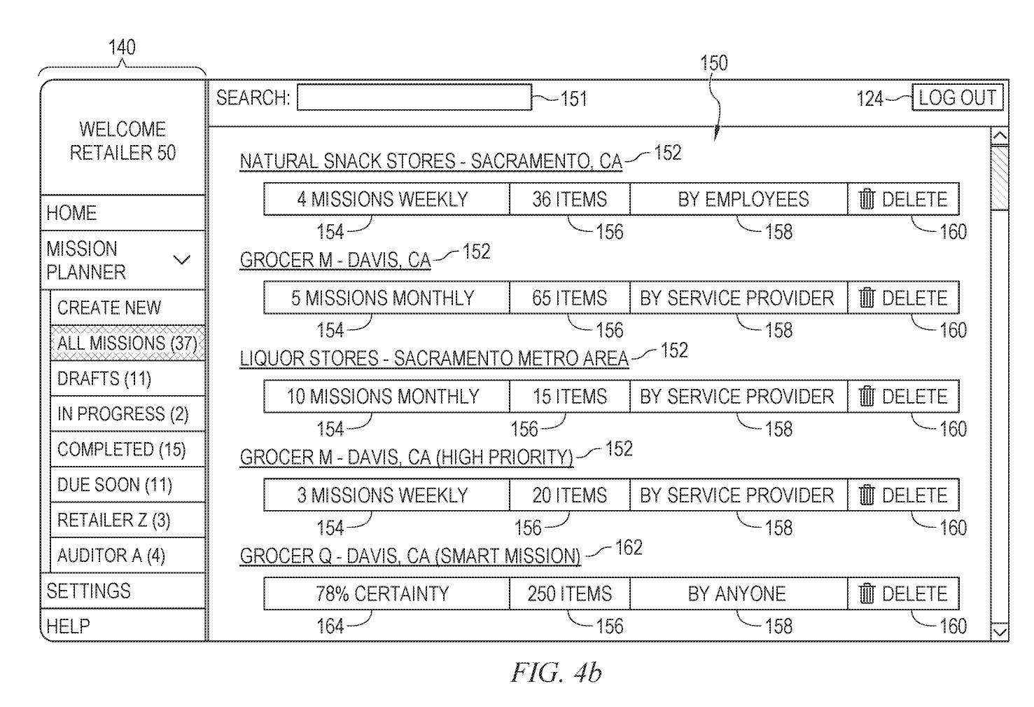

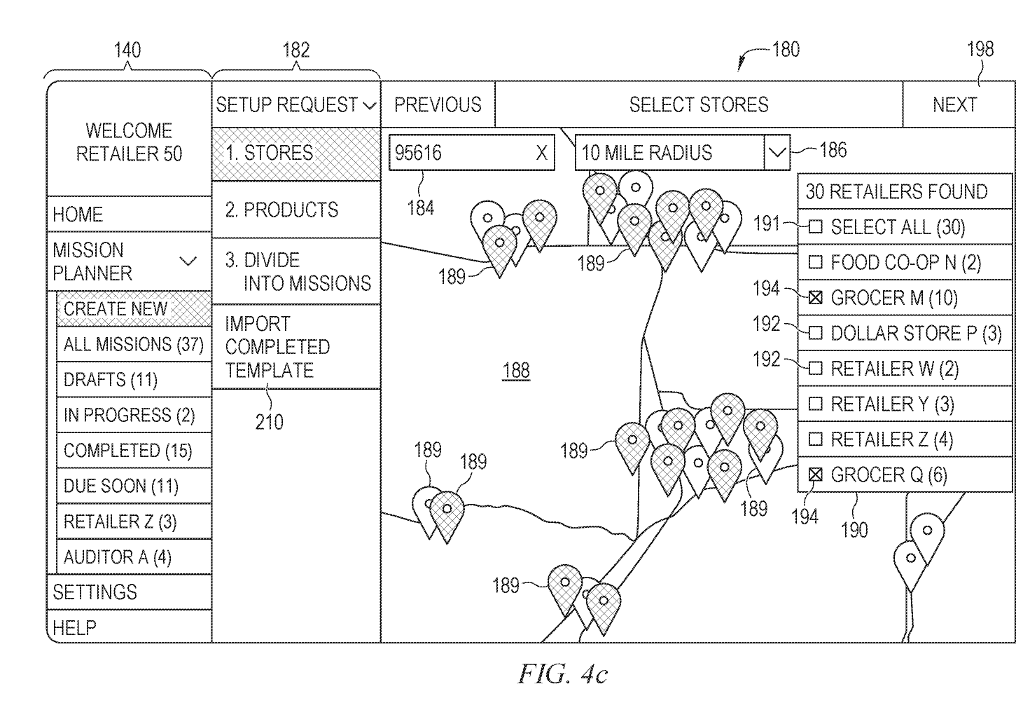

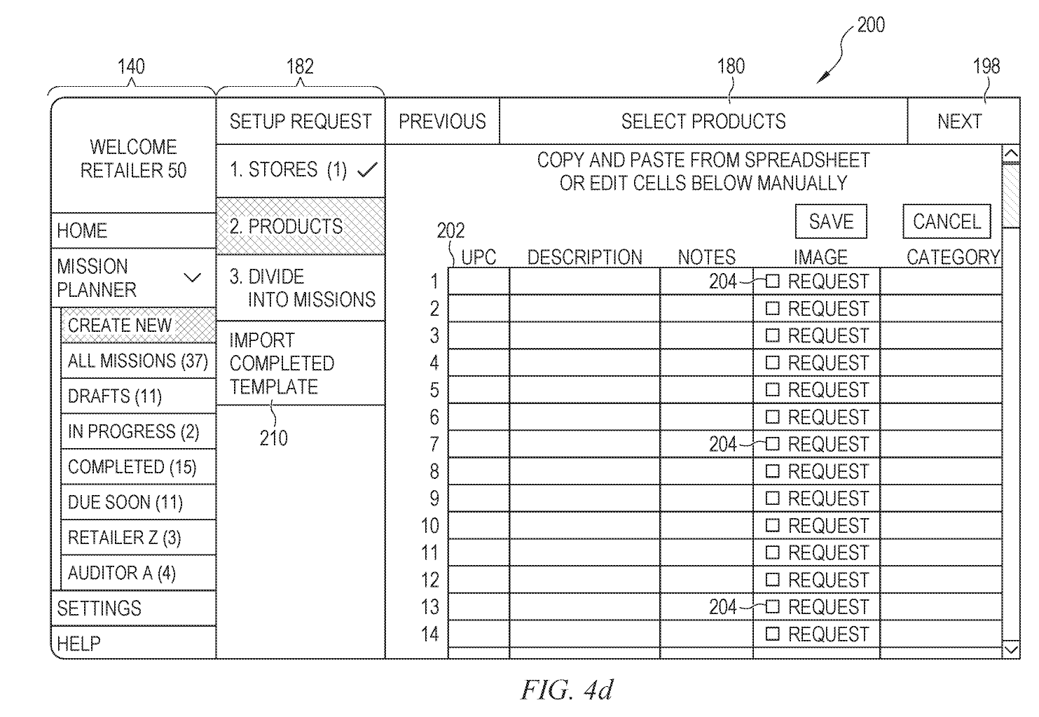

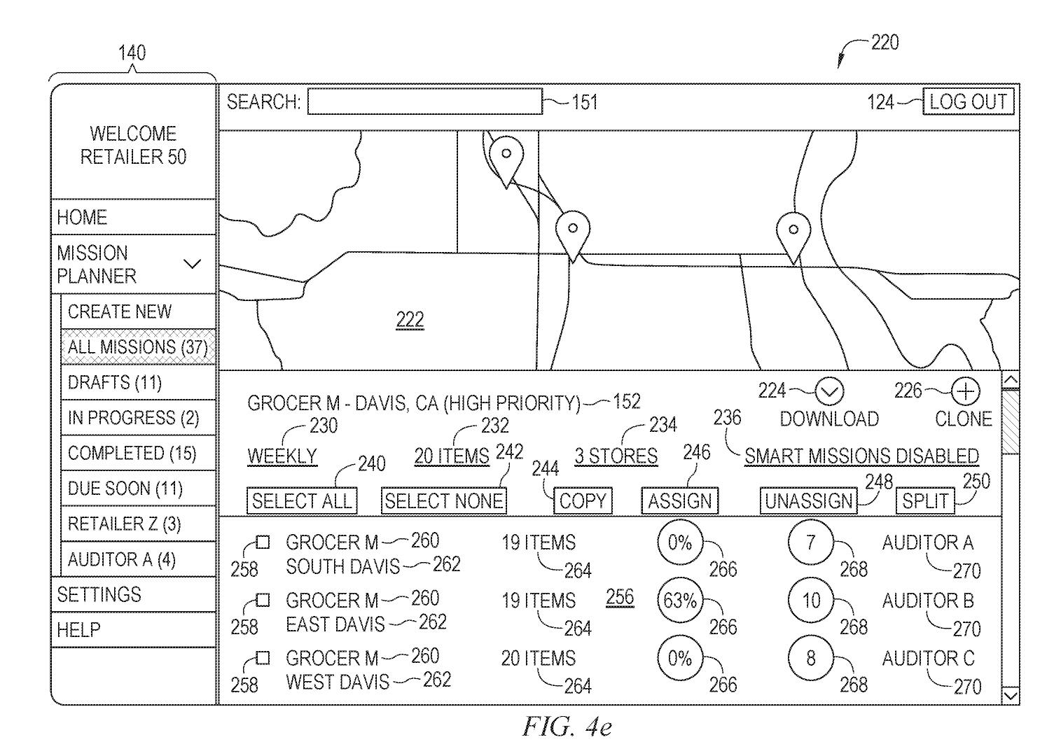

The representative of retailer 50 enters the requisite information into username field 102 and password field 104, and then clicks the log in button 106 to enter mission control website 100. Initially, retailer 50 is presented with a dashboard 120 as part of mission control website 100. Dashboard 120, as illustrated in FIG. 4a, shows a panoply of information of general relevance to retailer 50 as a summary. A header 122 of dashboard 120 includes a summary of the day's mission activities and a logout button 124. The summary in header 122 includes information such as statistics on missions accomplished so far today, missions due today that remain to be completed, total products shopped for prices so far today, etc. Logout button 124 allows the user to log out of their account to protect personal information of the user and confidential information of the retailer.

An interactive map 126 below header 122 gives an overview of the geographical area where retailer 50 is active. The region for a retailer may be a specific municipality, a portion of the United States, the entire United States, the entire world, or any other relevant geographical area. A user can zoom in or click to view more detailed information about a portion of the map. After zooming in, a user will eventually reach a view where individual retailers are discernable. Map 126 will indicate information such as retail locations that belong to retailer 50, competing retailers with competitive shopping missions set up, retailers with pending missions that are due to be completed soon, etc. Clicking on a retailer location will bring up a web page specific to the retailer, or to a mission at the retailer, that the user can then edit or simply view details of.

Dashboard 120 includes information tiles 130, 132, and 134 under map 126. Information tile 130 shows a total number of pending competitive shopping missions completed as a quick summary of progress being made. The statistic in information tile 130 can be set up by a user to limit the calculation to just the current week, the current month, all missions pending or that would have been pending if not already completed on the present date, or any other desired basis. Information tile 132 gives an overview of types of products that are currently set up to be monitored. Information tile 132 can reveal an overabundance of subscriptions for pricing of one category, e.g., alcohol or salty snacks, that is not actually important to the retailer. Information tile 132 can also reveal a lack of coverage for certain categories, e.g., meat and dairy or frozen food. Information tile 134 displays retailers that retailer 50 has missions set up for, and how many are completed or have pending missions to perform. Information tile 134 gives a simple view of which competitors are being monitored, and will allow the retailer to notice if certain competitors are not sufficiently monitored or are being excessively monitored.

Information tiles 130-134 are customizable by each user of mission control website 100. A user can change what information is highlighted first. Any number of additional information tiles can be added in additional rows, and the user can scroll down to view more useful summary information. Information tiles can be added or removed from dashboard 120 as desired.

Mission control website 100 includes a global navigation bar, or navbar, 140 that remains visible on all of the different web pages that make up the mission control website. Navbar 140 includes links to key pages of mission control website 100. Initially, navbar 140 includes links to dashboard 120 as “home”, as well as links to “mission planner”, “settings”, and “help”. Additional links can be provided for easy access to other useful pages of mission control website 100. The help option provides links to a user manual for website 100 or other documentation, a frequently asked questions (FAQ) section, a user forum, a page to submit bugs, and other pages useful when problems arise or simply to learn how website 100 works. The settings option allows a user to configure website 100 to his or her liking, for instance setting up e-mail notifications, adding information tiles for dashboard 120, or modifying default mission configurations.

“Mission planner” in navbar 140 takes the user to an area of website 100 for viewing, creating, and editing competitive shopping missions. Missions are created by a retailer setting up a mission request. In FIG. 4b, a user from retailer 50 has clicked on mission planner and is viewing a list of all requests that have been set up. The page header includes a search box 151 for searching missions or mission requests. A user can type a query into search box 151 to get results showing each mission request that includes a given retailer, a given product, or any other quality.

After clicking “mission planner” in navbar 140, additional sub-options appear below “mission planner”. The sub-options are tabbed to the right slightly to indicate the sub-options fall under the “mission planner” category. “Create new” allows the user to create a new mission request. “All missions” generates a mission request list 150 to the right that includes every mission request currently in central database 56 for retailer 50. Below “all missions” in navbar 140 are a series of options to display a mission request list 150 limited to certain categories. Some categories, such as “drafts”, “in progress”, “complete”, or “due soon” are options created by default. Retailer 50, or a particular user associated with retailer 50, can generate additional options based on search criteria, e.g., list of mission requests with missions assigned to Auditor A or a list of requests that include auditing Retailer Z. A number in parenthesis for each option indicates the number of mission requests that fit within the associated category.

Mission request list 150 is a list of each request that has been set up for retailer 50, and a few select details to help identify the request. Each mission request is identified by a title—generally a theme for the missions concatenated with a location for the missions. The theme can be based on a common retailer, a type of retailer, a category of products, another type of information that defines the missions, or combinations of the above. Users are able to rename missions to any appropriate name. Mission request list 150 includes two types of mission requests: normal mission request 152 and smart mission requests 162. Normal mission requests 152 include a fixed list of missions. Each mission from a normal mission request 152 includes all or a subset of the products requested at all or a subset of the retailers. The missions of a normal mission request 152 each include a fixed list of products that need to be price checked.

Mission summary block 154 shows how the mission request is generally split up, i.e., as four missions a week or five missions monthly. Normal mission requests 152 are most commonly split up based on retail locations. A mission request 152 might be for a specific retailer in a municipality, e.g., each location of grocery store chain M within the city of Davis, Calif. If there are five locations of Grocer M within Davis, Calif., the mission request can be split up into five missions, one for each retail location. Large mission requests 152 can be further broken down as needed. For instance, the products at each retail location within a mission request 152 can be split up by type of product, physical location within the retailer, importance of the products, or other categories. Breaking up missions by importance of price checking the products is beneficial because more important missions can be shopped more often than missions with less critical products.

Alternatively, retailer 50 can set up a separate request for high priority products. In FIG. 4b, retailer 50 has set up a lower priority Grocer M mission request 152 that checks lower priority products once a month, and a separate high priority Grocer M mission request 152 that checks a lower number of higher priority products weekly. Retailer 50 could have also set up a single mission request for Grocer M with both five low priority missions monthly and three high priority missions weekly.

Product count block 156 indicates the number of products being monitored under the request. Executor block 158 indicates who the mission request is set up to be executed by. Missions can be executed by employees of retailer 50, by professional auditors employed by service provider 52, by members of the general public acting as crowdsourcers, or by any combination of the above. Service provider 52 can be set up as a backup, so that normally only employees of retailer 50 will perform the missions, but if a mission becomes overdue, one of the professional auditors from service provider 52 will execute the mission. Alternatively, retailer 50 might decide that a certain mission is unlikely to be completed on time based on extant circumstances, and manually select for service provider 52 to execute the mission one time. Delete button 160 allows the user to delete an entire mission request if no longer needed. Alternatively, a mission request can be marked as a draft, which will not be executed.

The user from retailer 50 clicks on a mission to go to a separate page showing more detail of the mission request. Jumping to FIG. 4e illustrates a mission request overview page for the Grocer M high priority mission request 152. In some embodiments, clicking on the mission request 152 title goes to the mission request summary page in FIG. 4e, while clicking on the other blocks goes to other pages specific to view or edit detailed information related to the block clicked. Clicking on a mission summary block 154 takes the user to a page where the split of missions is viewable and editable. Clicking on an item count block 156 takes the user to a page that lists each item of the mission request and allows addition or deletion of products to be price checked. Clicking on an executor block 158 takes the user to a page that allows changing who is to execute the missions. Missions can be assigned on an individual basis within a mission request 152 to particular auditors of service provider 52 or employees of retailer 50.

Smart mission requests 162 appear differently within mission request list 150 from regular mission requests 152. Smart missions 162 do not include a fixed list of missions that are repeated at regular intervals like regular mission requests 152. Rather, smart missions 162 include a list of products that are audited as needed. Each item has a price certainty calculated based generally on how likely the price of the item is to have changed and how long since the item has been audited. Price certainty indicates a statistical certainty that the price stored for a particular product in central database 56 is correct. Smart mission requests generate missions on the fly as auditors request them. Smart missions are generated based on which items at the auditor's location have the lowest price certainty. Mission certainty block 164 displays the overall certainty for the smart mission request 162. The overall certainty of a smart mission request 162 is an aggregate of the price certainty of each product within the smart mission. Service provider 52 automates management of smart missions so that the highest priority products within the mission request at the time the mission is performed or created are the products audited. Smart mission requests generate flexible and dynamic missions rather than being a static list of products repeatedly checked by auditors.

To add a new mission request, a user clicks on “create new” within navbar 140. Creating a mission request first takes the user to a store selection page 180 with a secondary navbar 182. Navbar 182 includes links to jump to the various steps involved in creating a mission request, as well as other links to options for creating mission requests. The “stores” option under navbar 182 is highlighted to indicate that the user is viewing the page for setting up which stores to audit under the new mission request.

To select stores to audit under the new mission request, a user enters a geographical area within search box 184. The geographical area can be an address, a zip code, a city, county, state, etc. Range selector 186 is modified to select how far from the entered geographical area to include in the search. The range can be a certain radius from a point, or the user can select to include only locations within the exact geographical area entered in search box 184. That is, the user can search for stores within 10 miles of Davis, Calif., or could search for only stores strictly within the city limits of Davis.

Typing a geographical identifier into search box 184 and selecting a range in range selector 186 causes known retailers in central database 56 to be mapped out on map 188. Map 188 zooms in on the entered geographical area and range. Each known retailer in the area is placed on map 188 as a waypoint 189. Information regarding the retailers found within the geographical range is presented in overlay 190. In FIG. 4c, 30 total retail locations were found within a 10 mile radius of the zip code 95616. A user can check the “select all” check box 191 to add all 30 retail locations to the new mission request. The user can also select individual retailers by checking check boxes 192 next to the name of a retailer. In FIG. 4c, the user has selected check boxes 194 for Grocer M and Grocer Q to create a mission request for all grocers in the selected region. The waypoints 189 for the sixteen Grocer M and Grocer Q locations are highlighted on map 188. Alternatively, the user can select individual waypoints 189 to add or remove the associated retailers from the mission request.

Once the user has selected all desired retail locations for addition to the new mission request, the user clicks “next” button 198 to proceed to the next step: adding products to the mission request. FIG. 4d illustrates product selection page 200 for adding a plurality of products to the new mission request. Added products will be audited at each of the sixteen selected retailers on store selection page 180. In other embodiments, service provider 52 is aware that certain retailers have the same prices at locations within certain geographical areas. The two locations of same retailer may not need to be separately audited.

Store selection page 180 includes a table 202 for addition of products. Each row of table 202 is another product to be audited. The columns of table 202 are fields that define the product to be audited. The Universal Product Code (UPC) column can be manually entered, and the remaining fields are read from central database 56 for known products. In some embodiments, retailer 50 has uploaded the product database for the retailer to service provider 52. All product information for entered UPCs is read from the product information uploaded by retailer 50. Alternatively, the user can copy and paste an entire series of UPCs from a spreadsheet to bulk add products to table 202. The user can paste in only the UPC column, or can paste a two-dimensional table with any number of columns.

The description operates as a title for the product including name of the product, brand, type, and size, e.g., Brand K Three Cheese Macaroni and Cheese, 8 oz. The description can be read from central database 56, entered manually by the user, or read from the central database and edited by the user. The notes field offers bidirectional communication between a manager setting up the mission and the auditor in the field doing the price shopping. The manager setting up the mission might enter a note about multiple sections of the store a retailer might stock a product, whether the product has previously been found in comparable retailers, that an alternate store brand will need to be found, or provide a request to the auditor related to the specific product. The auditor can leave a note when performing a mission that the product couldn't be found, where the product was found, or a note about how the audited retailer runs sales for the product. Any message can be communicated between the manager and the auditor using the note field of each product. Alternatively, separate note fields can be provided for the manager and the auditor, or the notes can appear as a textual chat between the auditor and manager.

The image column provides an image of each added product. The images are read from central database 56 based on images from the product information uploaded by retailer 50 as part of the product information database, by an auditor while on an auditing mission, or by the manager while setting up the new mission request. If an image is not available, the user setting up the mission request can check a request image checkbox 204 to request the auditor take a photo of the product. When the product comes up for audit, the product page will notify the user that the auditor should take a picture of the product for future reference. The category column of table 202 allows the user to add or edit a category for grouping products. Grouping products by category can help break up mission requests into smaller missions that are logically organized based on products that tend to be located near each other at retailers. Categories can be anything that retailer 50 wants to use to group products. Commonly, categories will be sections of a grocery store, e.g., deli, frozen foods, fresh produce, salty snacks, toiletries, etc.

Once all products for the new mission request are added, the user presses “next” button 198 to advance to the next screen for grouping the mission request into individual missions. Service provider 52 will initially provide a default grouping, and the user can accept the grouping or further edit the missions. The default grouping is normally by retail location unless retailer 50 has changed the default. Grouping by retail location makes sense in most cases, so that auditors do not have to go to multiple retail locations within a single mission.

By default, service provider 52 will place each added product for auditing in a mission at each added retail location. In some cases, service provider 52 knows that a specific product is not for sale, or is unlikely to be for sale, at one or more of the retail locations, and will not add the specific product on the mission for that retailer. For some large mission requests, service provider 52 will automatically break up missions at a retail location by category. For instance, if 200 products are added, but retailer 50 has set up a maximum mission size of 75 products, service provider will automatically break up the missions at each retail location into three separate missions. In other cases, retailer 50 may configure service provider 52 to group retailers within geographical areas. Instead of having separate missions for each location of a retailer within a geographical area, service provider 52 creates a single mission for all locations. An auditor can audit any location of the retailer within the geographical area and the collected prices will be presumed valid for other nearby locations.

As an alternative to the three phase process described above for generating a mission request, a user can fill out a mission request template offline and upload the mission request template through import button 210. Import button 210 allows the user to generate a mission request file based on a template from service provider 52. The mission request file can be a spreadsheet file, a comma-separated variable text file, a database file, or any other data file format.

FIG. 4e illustrates a mission request home page 220. Mission request home page 220 can be viewed automatically after creation of a new mission request, or can be navigated to by clicking on a mission request 152 in mission request list 150. Mission request home page 220 in FIG. 4e illustrates the home page for the high priority Grocer M mission request from FIG. 4b. A map 222 on the top half of mission request home page 220 illustrates the location for each retailer audited under the particular mission request.

Mission request home page 220 includes a header with the title of the particular mission request 152, a download button 224, and a clone button 226. A user can click download button 224 to download a data file including all information for the mission request. The downloaded data file can include all current audited prices along with all product information entered by a manager or auditor or read from central database 56. The downloaded data file can optionally include all historical prices audited since the mission request was created. The downloaded data file may be limited to only a single mission, a single retailer, or any other factors. In some embodiments, clicking download button 224 opens a context menu giving a number of options for exactly what data to include in the downloaded file. The downloaded file can be a database file, a spreadsheet, a text file, or any other suitable file format.

Clone button 226 creates a copy of the mission request in central database 56. Clone button 226 is used to create a new mission request based on an existing mission request. The cloned mission request copy can be used as a backup, while a manager tests different options on the existing mission request. In another use-case, clone button 226 is used to create a copy of a mission where all of the retailers are then changed, but the same list of products is audited. Clone button 226 then removes the need to re-add products to create multiple mission requests for different retailers with the same list of goods. Alternatively, clone button 226 is used to create multiple mission requests with the same set of retailers but replacing the products list with products in a different category.

The header of mission request home page 220 includes a second row with cadence indicator 230, item indicator 232, store indicator 234, and smart mission indicator 236. Cadence indicator 230 indicates how often the missions are configured to be executed. In FIG. 4e, the missions are configured to be executed weekly. Clicking cadence indicator 230 allows a user to modify the missions to be executed on any desired cadence, e.g., every 10 days, bi-weekly, or monthly. Item indicator 232 indicates the total number of items for the mission request, twenty items in FIG. 4e. Clicking item indicator 232 provides a list of items for the mission request. Store indicator 234 indicates how many retail locations are encompassed by the mission request. Clicking store indicator 234 gives information as to which retailers and retail locations are covered. Smart mission indicator 236 indicates whether the mission request is set up as a smart mission, and allows a user to switch smart missions on or off for the particular mission request.

The header includes a third row with select all button 240, select none button 242, copy button 244, assign button 246, unassign button 248, and split button 250. The buttons of the third header row are used to make modifications to selected missions in mission list 256. Mission list 256 below the third header row includes each mission of the mission request. Each mission has a checkbox 258 used to select one or more of the listed missions. Clicking a checkbox 258 generates a checkmark or other symbol in the checkbox and indicates that the clicked mission is selected. Clicking multiple checkboxes 258 allows selection of multiple checkboxes. Clicking select all button 240 selects all checkboxes 258 in one click. Select none button 242 unselects each mission in a single click. Copy button 244 is used to copy a mission either to the same mission request or to another mission request. Clicking assign button 246 allows a user to assign particular missions to a different auditor. Unassign button 246 allows missions to be unassigned from all auditors. Unassigned missions are disabled and will not be executed, or can be configured to default to crowdsourcers or any available employees of service provider 52 or retailer 50. Split button 250 allows a user to split up any selected missions into multiple missions.

Mission list 256 is a list of every mission that makes up the mission request currently being displayed on mission request home page 220. In the present case, the high priority Grocer M mission request includes three different Grocer M locations in Davis, Calif., with one mission per location. Each mission includes a selection checkbox 258, a retailer name 260, a retailer location 262, an item count 264, a completion percentage indicator 266, a completion rating 268, and an auditor assignment indicator 270. Retailer location 262 can indicate the particular location by address, description, franchise number, or any other unique identifier. Item count 264 indicates how many of the overall items are being audited for that mission. A mission might have less items than the mission request if a user manually removed the items from that mission. Alternatively, items can automatically be removed if the store is known not to include some of the items in the mission request. Through audits, service provider 52 learns what products retailers actually carry to improve mission generation. Service provider 52 can also predict if a retailer carries a particular item based on the size of the retailer and if similar retailers carry the product in the same geographical region.

Completion percentage indicator 266 indicates what percentage complete the current iteration of the mission is. Completion rating 268 indicates a rating of how well the mission has been completed historically. If the mission has always been completed on time every week, the rating is 10. The more an auditor is late in executing a mission, or if other problems exist in the completion of the mission, the rating is reduced. A manager can get a quick view of how auditors are doing by glancing over the completion ratings 268 for the mission request. Assignment indicator 270 lists which particular auditor, if any, is assigned to each mission. A user can click the assignment indicator 270 to change which auditor is assigned, or select multiple missions using checkboxes 258 and click assign button 247 to update multiple auditors at once.

FIG. 4f illustrates a mission request home page 220 for a smart mission request 162. Smart mission requests 162 are not split up into predefined missions as normal mission requests 152 are. Similar to normal mission requests 152, smart mission requests 162 are defined by a list of stores and a list of products to audit at those stores. However, smart mission requests 162 generate missions on the fly as requested by auditors. Rather than displaying a list of missions 256, smart mission request 162 includes a list of products 280. Each item can be included on the list multiple times, one for each retail location, or each item can be considered audited for all locations based on an audit completed at any of the locations. In some embodiments, products are included at each retail location, but price checking at one location will raise the price certainty for the same product at nearby locations.

Each product in smart mission request 162 includes a description 284, a volatility rating 286, an online reliability rating 288, a freshness rating 290, an exposure level 291, and a certainty rating 292. Smart mission requests generate missions to substantially maximize price certainty of the basket of products for the smart mission request 162. Therefore, a lower price certainty rating 292 makes price checking a product more important. Price certainty is calculated by a formula considering price volatility 286, online price reliability 288, price freshness 290, and price exposure 291. In other embodiments, other factors are considered.

Price certainty 292 is a number determined statistically based on all available information, and indicates the likelihood that a price in the database is still the current price. Volatility rating 286 indicates how often the price of the product normally changes. A higher volatility means the price of the product changes more often, or is regularly included in a variety of sales, and needs to be audited more often. Volatility ratings can be determined or made more accurate over time as a product is priced week after week. Service provider 52 automatically updates the volatility rating 286 of a product as additional data points are collected.

If the price of a product changes often, the more volatile price must be checked often to ensure accuracy of the price stored in central database 56. For instance, many soft drink manufacturers execute new price promotions every week, so the price of soft drinks might need to be checked every week to remain accurate. On the other hand, products such as consumer electronic devices have controlled prices that rarely fluctuate. Many products have a natural frequency with which price changes normally occur. Service provider 52 can prioritize product audits to time auditing along with the natural frequency of price fluctuations to maximize benefit of the audits.

Online price reliability rating 288 indicates how accurate the online prices for the product is at the retailer. If an accurate online price is available, the certainty of a product price is higher, and the product needs to be audited less often. In some embodiments, online price reliability rating 288 is a binary option, indicating whether or not an online price at the retailer matches the price in-store for the retailer. The smart mission request 162 can automatically generate smart missions to audit products with accurate online prices once per quarter, once per year, or some other cadence less frequent than other products, to validate that the items still have the same price online as in-store for specific retailers. In the meantime, online prices are monitored rather than continuing to audit in-store. Those items with the same price at a retailer online and in-store become lower priority for in-store auditing at that retailer because the price can be obtained from a webcrawler or by otherwise monitoring the price online. Items that were determined to have prices online that correlate to prices in-store at a particular retailer are checked less frequently by in-store auditing relative to products with prices online and in-store that do not correlate.

Price freshness 290 indicates the number of days since the price for a product was audited. Price certainty 292 of a product decays with time, because the longer ago a price was audited, the more likely the price is to have changed. Freshness 290 is correlated to certainty 292 by volatility 286. More volatile prices become uncertain quicker over time, while less volatile prices stay more certain longer.

Exposure 291 indicates how much exposure the price of the product has to consumers. Products that are generally purchased by more people, and more often, have a higher priority. High volume or velocity of product sales makes the price of a product more visible to consumers. Staples like bread, milk, and rice need to be priced properly because of the high exposure resulting from high sales volume. Too high of a price quickly results in a poor price image for retailer 50, while too low of a price quickly erodes profits unnecessarily. Most retailers have around 30,000 items for sale. Eighty percent of sales, and eighty percent of revenue, commonly come from only twenty percent of items in stock. Moreover, eighty percent of the first eighty percent of revenue comes from twenty percent of the first twenty percent of items. Therefore, sixty-four percent of a retailer's revenue may come from only four percent of the total variety of products carried by the retailer.

The high visibility of that four percent of products makes accurate pricing, and thus accurate price intelligence, very important for that set of products. Pricing high revenue items too high results in consumers develop a negative image for pricing at the retailer. Pricing high revenue items too low results in a large hit to the retailer's margin. For products with a low exposure 291, a lower price certainty will be acceptable, while prices with high exposure demand maintaining a high price certainty. In some embodiments, exposure 291 is considered in the calculation of certainty 292. Smart missions are generated based on only which products have the lowest certainty. In other embodiments, exposure 291, along with other signals including certainty 292, is used to generate a priority rating for each product. Smart missions are generated based on which products have the highest priority.

Price certainty 292 is calculated based on the signals provided by volatility 286, online reliability 288, freshness 290, as well as other available input signals. Several other signals are used to determine which items are the highest priority to audit. Service provider 52 monitors cost changes for manufacturers' products, because if a manufacturer changes the wholesale price of a product, or the MSRP of a product, then the price at retailers is likely to change shortly thereafter and should be set to a higher priority. In addition, if the cost of raw materials rises significantly then products that are made with the raw material are likely to be volatile, raising the priority of auditing. Priority changes depending on stages of a product's life cycle. New products may be higher priced and rarely on sale, with sales being more common later in the product's life.

Service provider 52 understands price leaders and price followers among retailers. Many retailers in a geographic location follow the lead of another retailer on pricing certain items. When a price leader changes the price of an item, the same item at follower retailers becomes a higher priority to audit because a price change is likely imminent at the follower retailers. Service provider 52 is further able to monitor historical trends to determine which retailers are leaders and followers for particular items. In some cases, two retailers' prices are correlated such that when one changes a price, the other is likely to change, even though the first retailer is not always the leader and the second retailer the follower. The price at the second retailer can be triggered for an audit or assumed to change along with the first retailer.

Correlations between retailers can be based on price zones. Price zones may be a geographic region of stores that tend to be similarly priced. The zone can be based on competition among retailers, e.g., stores near Wal-Mart may be forced to price items along with prices that Wal-Mart sets. A price zone may be an urban area or rural area where prices are generally set similarly among retailers. In general, any grouping of stores can be a price zone. Service provider 52 can perform an audit at any store within the price zone and apply the audited price to all stores within the price zone. Price zones can be pre-determined by service provider 52 and selected by a user, or the user can setup price zones as desired.

Service provider 52 uses strategic sampling to ensure the relationships between price correlations are maintained. Strategic sampling is useful for higher profile items such as milk and bread. Strategic sampling verifies the integrity of price correlations between retailers, between online and in-store prices, within price zones, or other established correlations. Prices for correlated products are checked against each other periodically to ensure that the prices remain correlated.

Smart missions are optimized to minimize price uncertainty to the extent that the budget of retailer 50 to pay auditors allows. Service provider 52 is capable of forecasting what the impact of an audit will be, e.g., the increase in profitability that will result from the increase in accuracy of competitive price intelligence. Service provider 52 can estimate return on investment and optimize missions to maximize return.

Service provider 52 looks at each item in a central database containing each item known for each retailer, and figures out the right timing for each particular item based on all the available competitive price signals, online signals, and cost signals. All of the available signals are inputs to a predictive model, and missions are optimized based on the signals so auditors check prices for the right items at the optimal time. Missions generated from smart mission requests are optimized by service provider 52 based on all input signals.

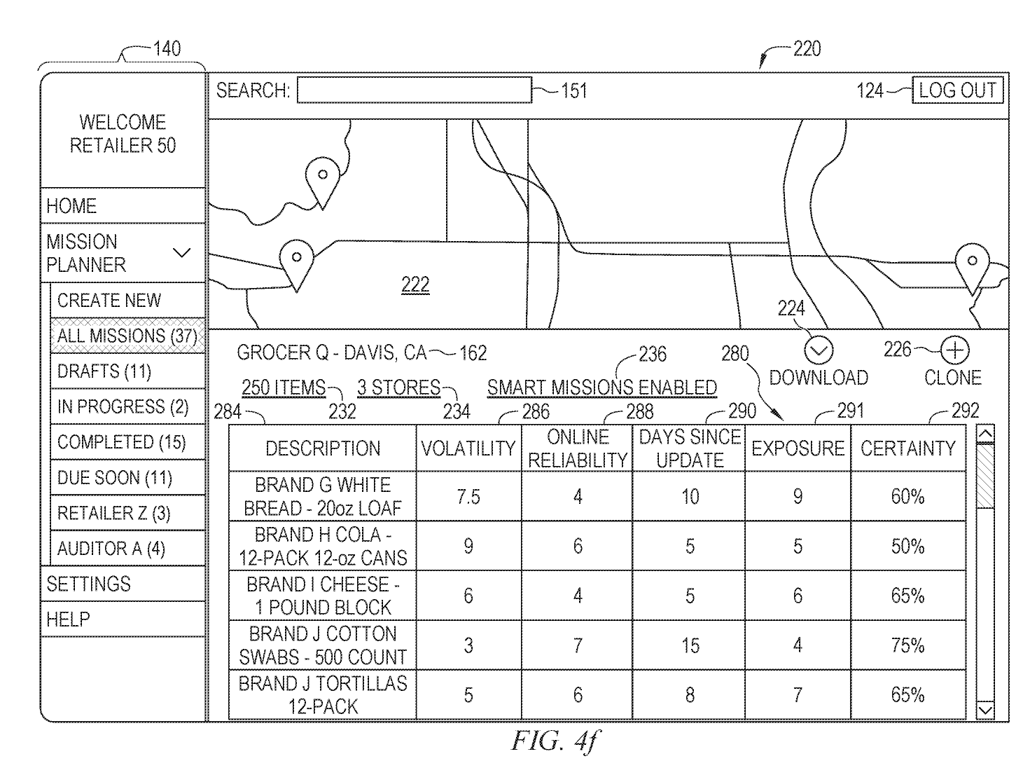

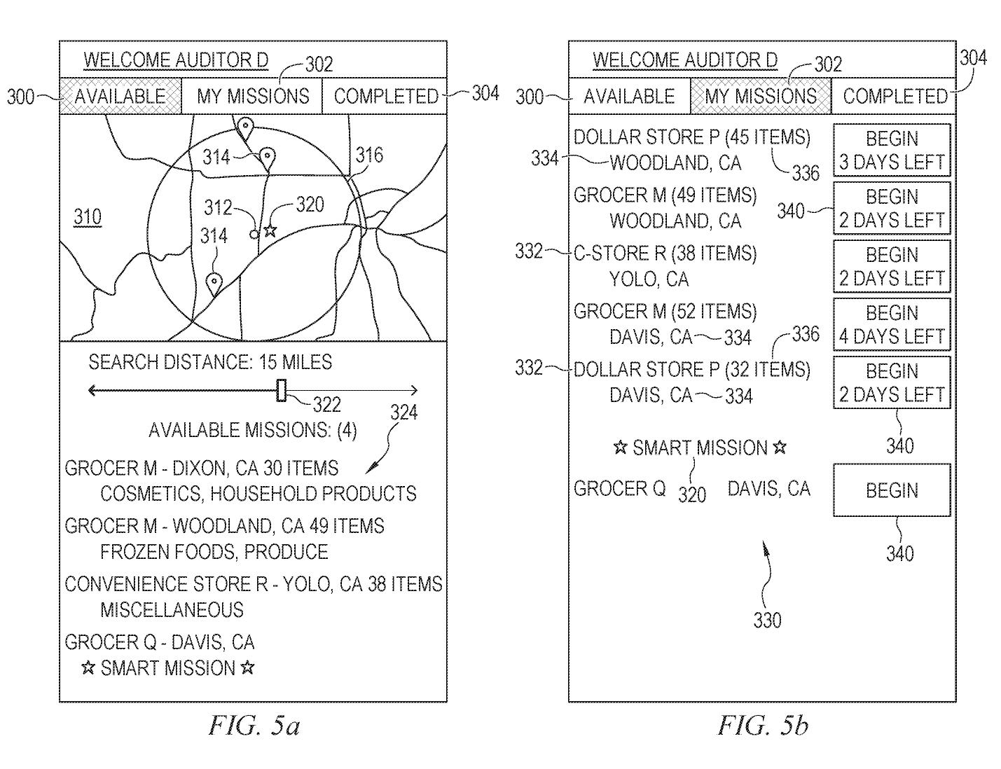

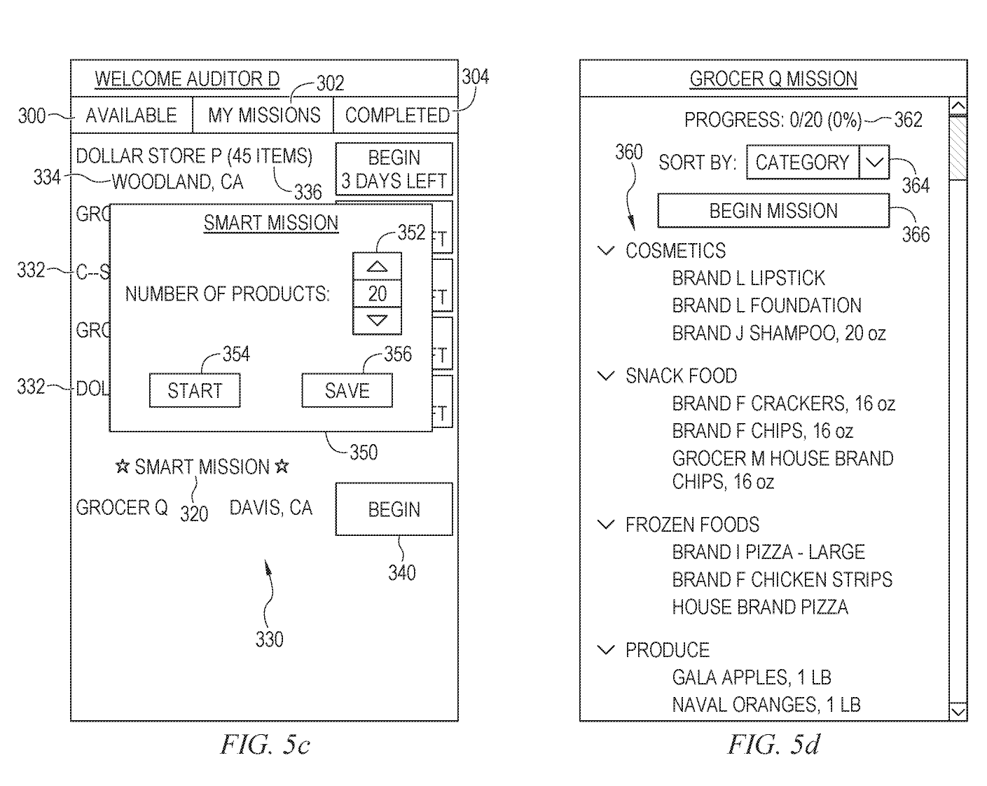

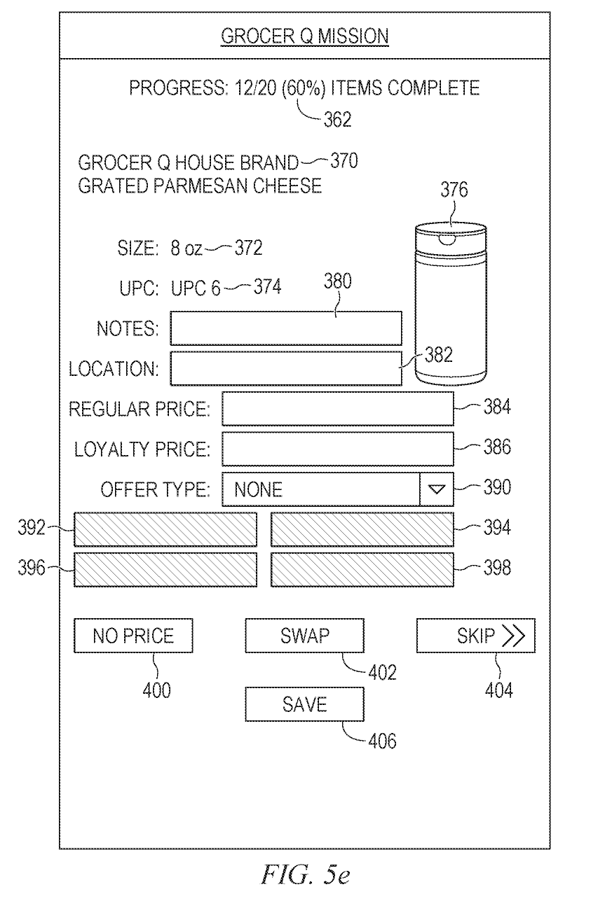

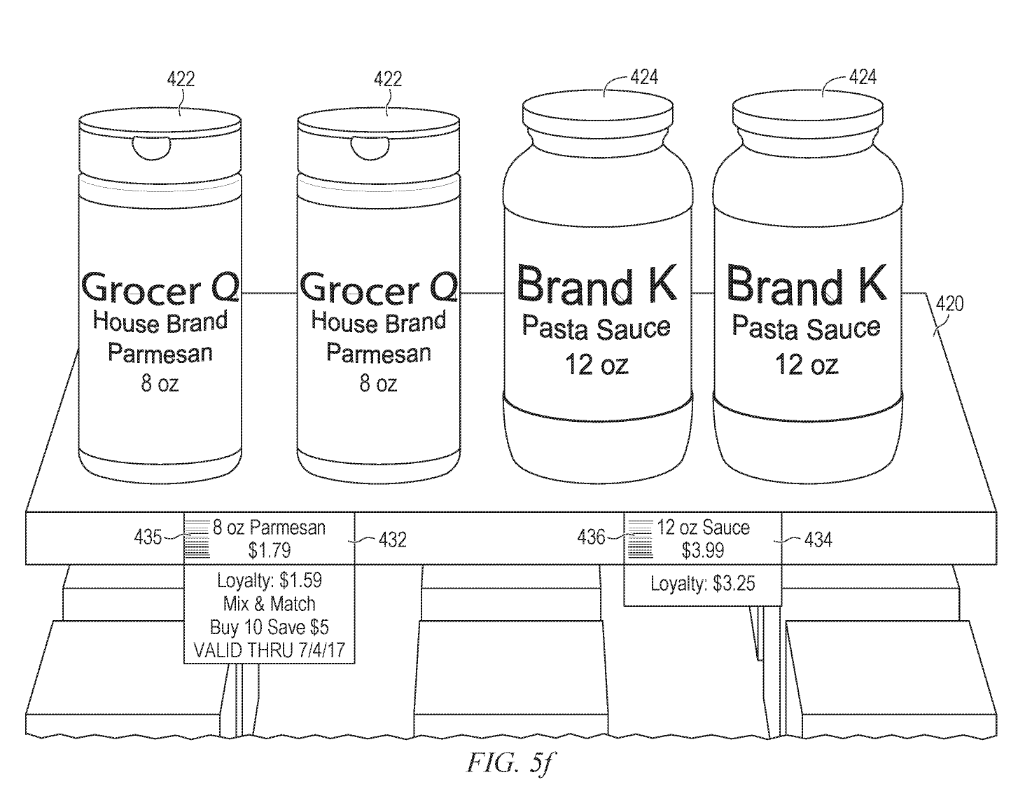

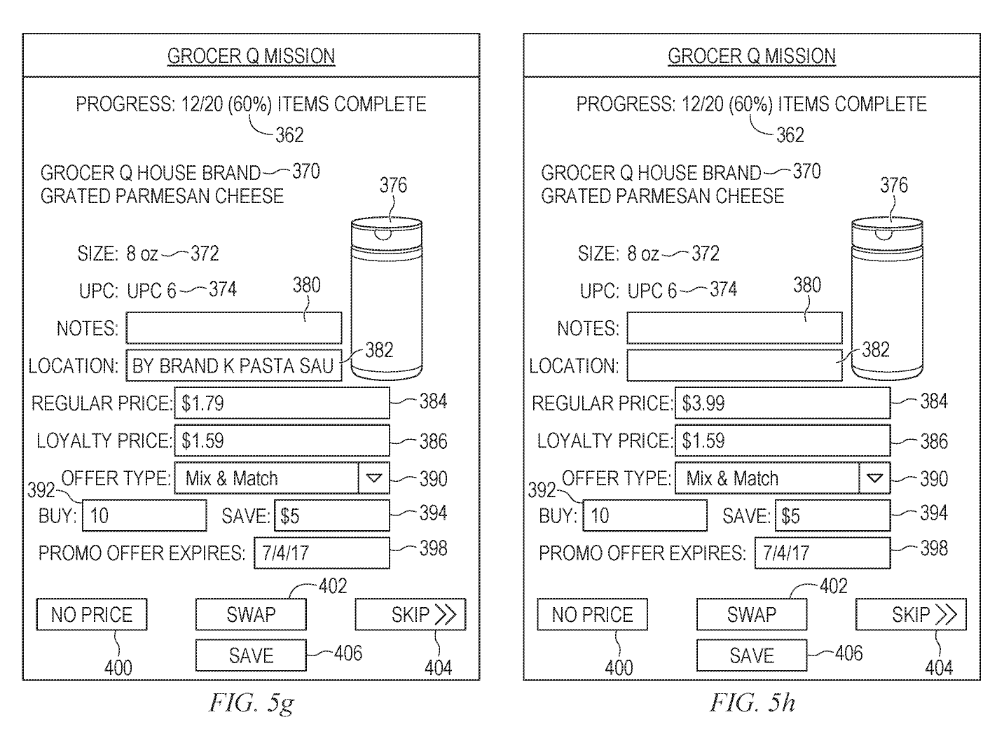

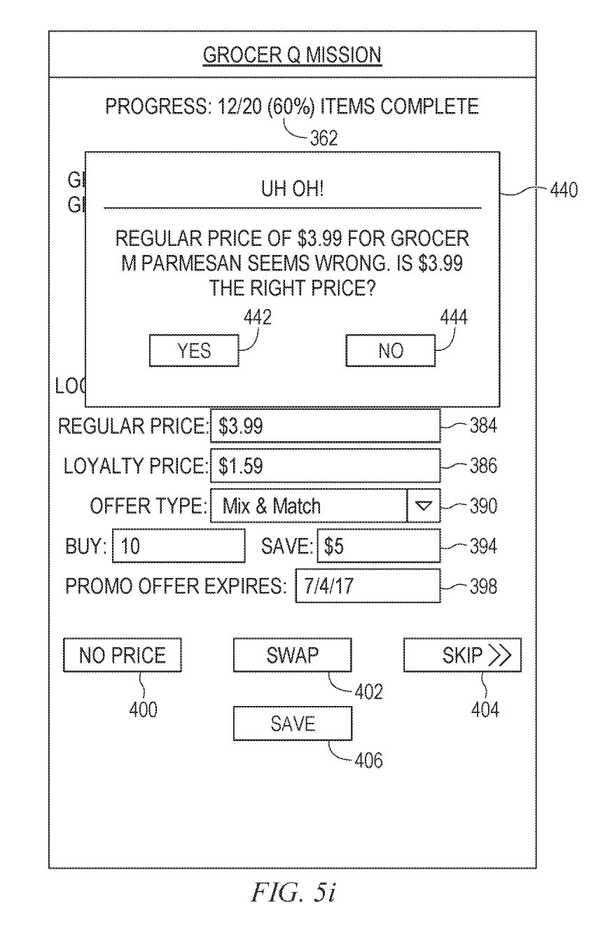

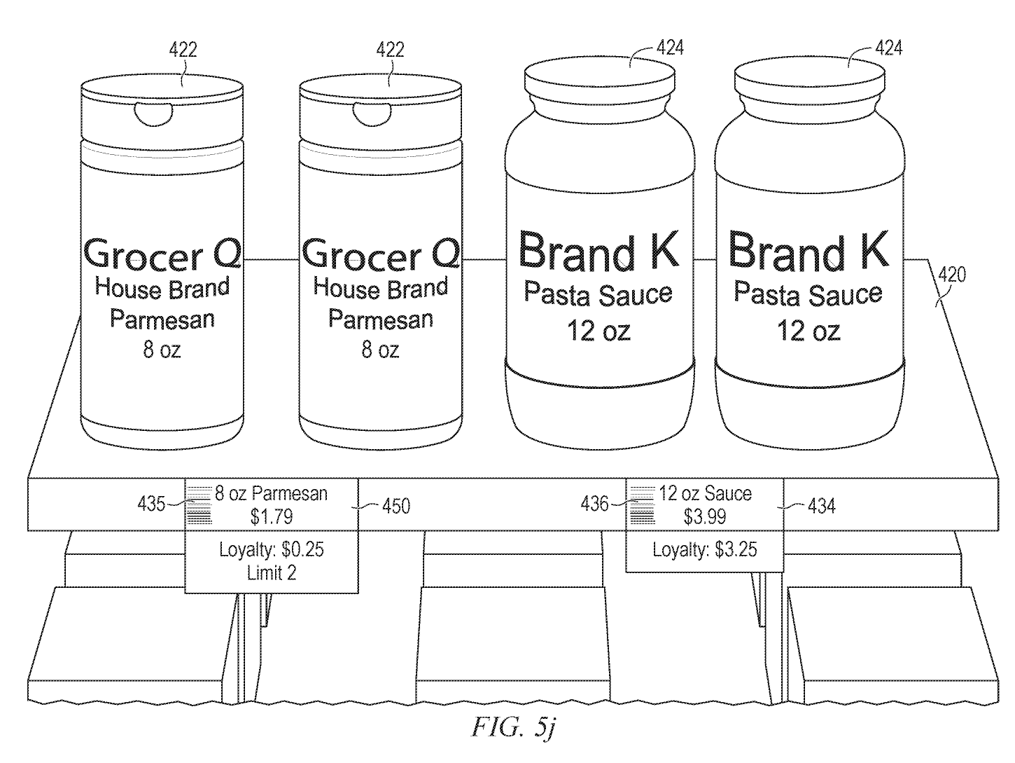

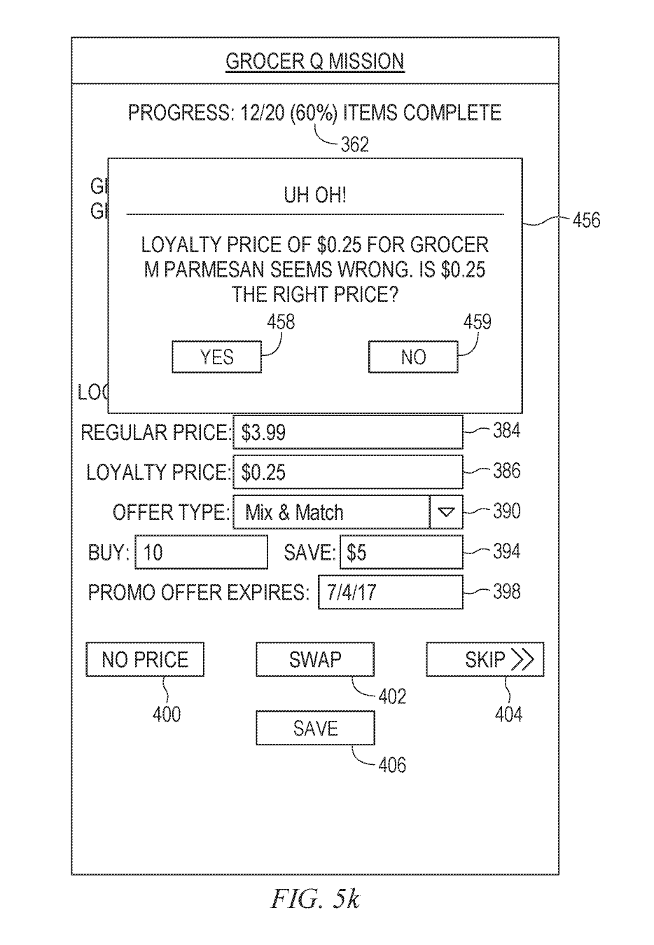

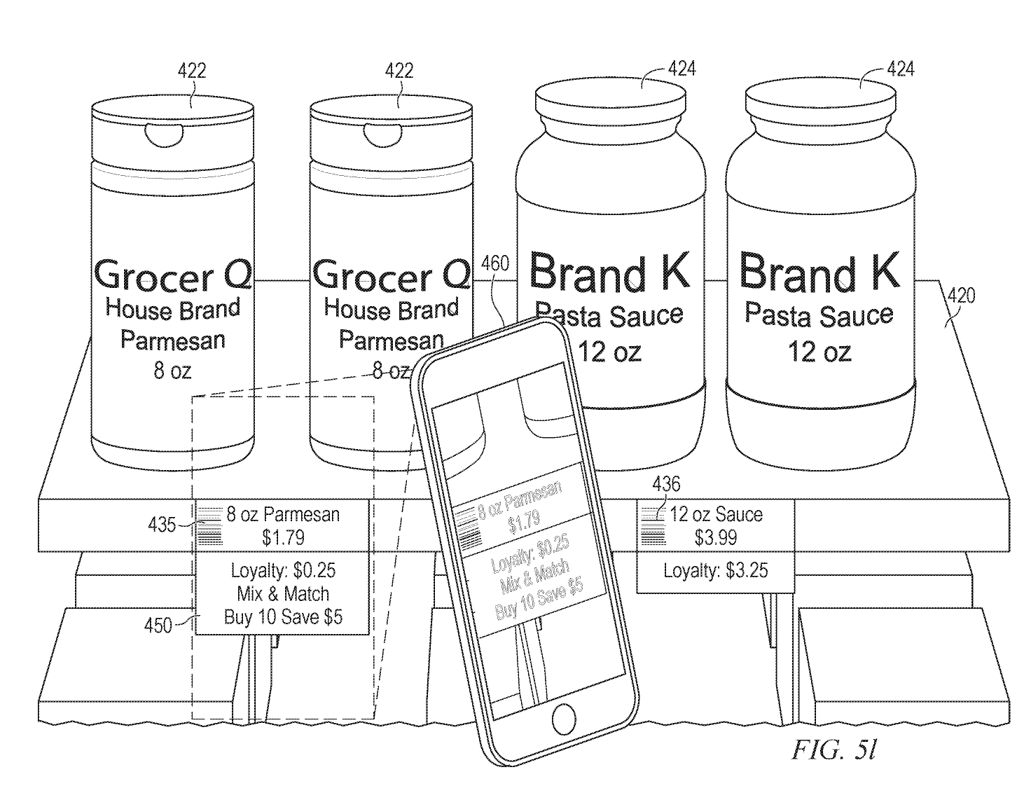

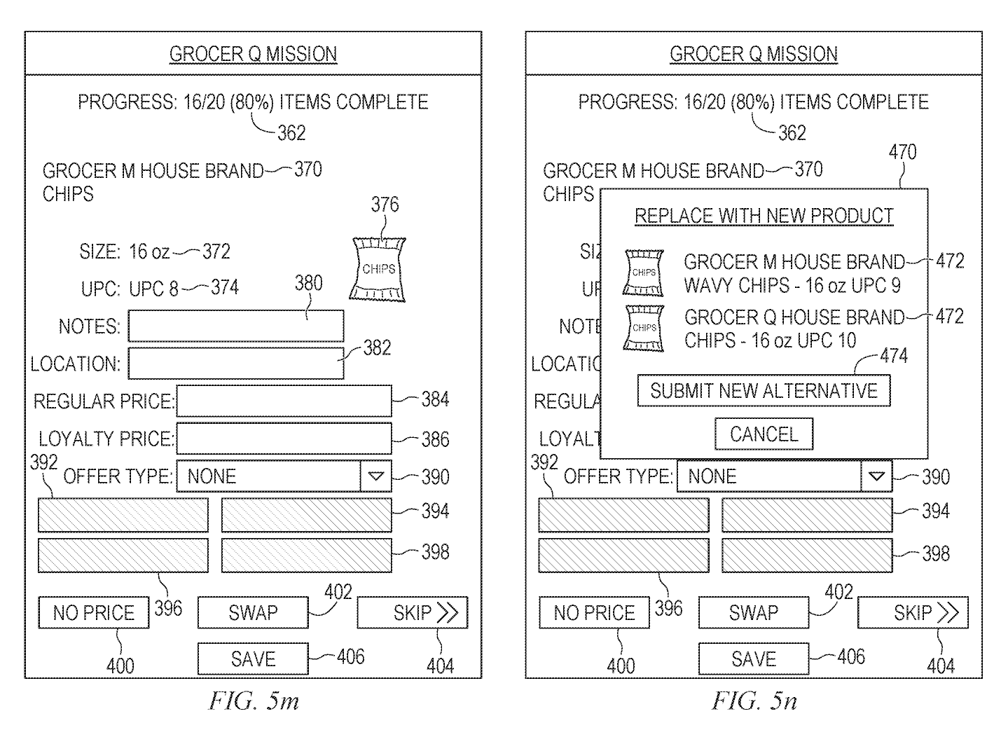

After mission requests are set up by a manager or other authorized employee of retailer 50, the missions become available to auditors. Whether an auditor is an employee of retailer 50, service provider 52, another auditing firm, or a member of the public taking part in crowdsourcing, the auditor generally uses a cell phone or other mobile device application provided by service provider 52 to perform the audit. FIGS. 5a-5n depict screenshots of the mobile application while Auditor D selects and executes a comparison shopping mission.

The app home screen includes three main tabs: available missions tab 300; my missions tab 302; and completed missions tab 304. Available missions tab 300 displays nearby missions that need to be completed, allowing an auditor to claim the missions. My missions tab 302 shows a list of missions that have been assigned to the auditor and need to be executed. Completed missions tab 304 allows the user to review, update, or correct previously completed missions.

FIG. 5a illustrates the available missions tab, which allows an auditor to view nearby missions that need to be completed. A map 310 shows the auditor's location 312 and missions 314 that fall within a selected radius 316 of the auditor. Optionally, available smart missions 320 nearby are marked differently to indicate smart mission status. Smart mission 320 is indicated by a star icon in FIG. 5a, letting the auditor know that a smart mission request can generate a smart mission at that location. A radius slider 322 allows the auditor to modify the radius 316 to look for mission farther away or to limit the distance of missions. Mission list 324 shows each mission found within the selected search radius. Auditor D can tap on the missions on map 310 or within list 324 to see more details or add the missions to my missions tab 302.

FIG. 5b illustrates my missions tab 302 selected to view missions assigned to Auditor D. Missions in my missions list 330 are assigned to Auditor D either because a manager selected Auditor D to execute the missions, or because Auditor D claimed the mission from available mission tab 300. Each of the missions in list 330 includes a store name 332, a store location 334, an item count 336, and a begin button 340. Other identifying or useful information is also provided in other embodiments. Begin buttons 340 indicate how many days until each mission is due, so that Auditor D can see which missions have due dates soon. Some embodiments order the list by due date, so that more critical missions are listed first.

When smart mission 320 is added to my missions tab 302 from available missions tab 300, the smart mission becomes listed but no specific mission is generated. Smart mission 320 does not indicate a due date, because smart mission requests are continuous and do not have a specific due date. In some embodiments, begin button 340 for smart mission 320 indicates an uncertainty level, or how critical auditing of the smart mission is currently. As more product prices within smart mission 320 become more uncertain over time, the importance of auditing the smart mission can be communicated to Auditor D through an indicator in begin button 340 of the smart mission.

In FIG. 5c, Auditor D selects to begin smart mission 320 and is prompted by popup 350 to select how many products to audit. Auditor D can select a number based on how much time is available to perform the comparison shopping. In FIG. 5c, Auditor D selects to audit twenty products, and clicks start button 354 to begin the mission. Alternatively, if Auditor D is not quite ready to begin the mission, Auditor D can click save button 356 to save the generated smart mission as a normal mission with a list of products under my missions tab 302. In either case, the mission is generated by service provider 52 based on the highest priority products within the smart mission to audit at the time and at the auditor's location. Because the mission generated for Auditor D based on smart mission 320 reserves the most important products to audit, and those products may no longer be available when other auditors generate other smart missions from smart mission request 320, Auditor D may be given a short period of time in which to complete the mission. In one embodiment, Auditor D must begin the smart mission within one or two hours of generation or the smart mission is removed from my missions tab 302. In some embodiments, smart mission 320 is only active in my missions tab 302 when Auditor D is actually at the premises of Grocer Q to begin executing the generated mission.

FIG. 5d illustrates a summary page including a collapsible list 360 of each product of a mission selected for execution by Auditor D. A similar list 360 is presented when beginning a mission based on a regular mission request or a smart mission request. List 360 can be returned to at any time during auditing the mission to view progress or the list of remaining products. A progress indicator 362 indicates the number of products completed, total number of products, and a percent completion.

Sort by selector 364 allows Auditor D to modify how product list 360 is organized. Product list 360 can be organized by importance of auditing each product. Products with higher price uncertainty are listed first, which can help if Auditor D only has time to audit a portion of the mission. Auditor D can do the most important products first. Product list 360 can be audited by Category, which generally allows the user to stay in one area of a grocery store until the category is complete, and then move to another area of the grocery store. In some cases, service provider 52 actually knows where products are located in a retailer, and can generate an optimized order that minimizes the linear feet that Auditor D has to walk in a retailer to audit the entire mission.

Auditor D can click on any of the products in product list 360 to bring up a page specific for that product that allows entry of a price. Alternatively, Auditor D can tap on begin mission button 366 to pull up the product page for the first product. Once a page is fully populated, the user clicks save to automatically proceed to the next product from product list 360.

FIG. 5e illustrates a product page ready to be audited by Auditor D. Progress indicator 362 remains, but is now at 60% completion. The current product 370, house brand grated parmesan cheese, is the thirteenth of twenty items of the mission. Auditor D is given product details 372, UPC 374, and image 376 to help find the product on the store shelf of Grocer Q. If any notes were previously entered, the notes will be seen in notes field 380 and may be of help to Auditor D. Additionally, Auditor D can modify note field 380 to enter any helpful information for next time. Location field 382 may be populated and indicate a specific location within the retailer where the product is located, e.g., aisle and bin number. Auditor D can also enter a location if desired once the product is found.

Service provider 52 helps Auditor D find items if the auditor has trouble. Service provider 52 tracks how retailers cross-merchandize items. If an item could be in three or four different places within a retailer's premises, service provider 52 provides a list of possible locations through location field 382. For instance, cotton swabs could be with automotive products, baby products, or make-up. Salsa could be located with chips, condiments, or Mexican food. Service provider 52 can also confirm that a product was found at a retailer on a previous audit, and where, to reduce the likelihood that Auditor D wanders around the retailer searching for a product that is not carried. Service provider 52 helps Auditor D determine if an item that the auditor cannot find is not carried at retailer, or if the item is merely difficult to find. Service provider 52 also knows when a retailer does not carry an item, and can leave the item off mission lists for that retailer to save Auditor D time. Beacon technology, GPS, or manual entry can be used to track where a product is found on each auditing mission. The app used by auditors to execute missions can present a list of previous locations where the product was found when the product is displayed for auditing.

Regular price field 384 and loyalty price field 386 are the fields where Auditor D is to enter the prices for the product displayed. The regular price that Grocer Q charges for the product is entered into regular price field 384. A loyalty price that Grocer Q offers to customers who sign up for a loyalty card and use the card at checkout is entered into loyalty price field 386.

Offer type selector 390 is used by Auditor D to select if the current product is subject to any additional discount offers. Auditor D selects the offer type from offer type selector 390, and then the offer fields 392-398 are enabled and labelled based on the context of the selected offer type. Examples of the offer type are mix-and-match discounts, buy-one-get-one free, discounts with the purchase of two different related products, etc.

If a product is not available or cannot be found at Grocer Q, Auditor D can use no price button 400 to indicate that no price is available for the product. If Auditor D wants to skip the product without affirmatively indicating that the product was not found or no price is available, skip button 404 is used. Save button 406 saves the entered information and automatically advances to the next product to be audited or returns to product list 360. Swap button 402 allows Auditor D to swap out the displayed product for a comparable product if necessary. Swap button 402 is explained in more detail below with respect to FIGS. 5m and 5n.

When a new product page is displayed for auditing, house brand grated parmesan cheese in FIG. 5e, Auditor D finds the product within the premises of retailer. FIG. 5f illustrates a portion of a retail store shelf 420 where Grocer Q stocks their house brand parmesan 422 next to Brand K pasta sauce 424. Each product includes a price tag attached to store shelf 420. Price tag 432 is attached to shelf 420 below house brand parmesan 422, and price tag 434 is attached to shelf 420 below Brand K pasta sauce 424. Price tag 432 has a graphical UPC 435 that can be compared to UPC 374 to verify that the price tag is for the correct product being requested for audit. Price tag 434 includes a UPC 436. Price tag 432 indicates that the parmesan has a regular price of $1.79 and a loyalty price of $1.59. Price tag 432 further indicates that parmesan 422 is part of a mix and match program where buying ten eligible products saves $5.

Auditor D verifies that the product details 370, 372, and 374 match the details of product 422, including those printed on price tag 432, and then enters the prices in fields 384-398 as shown in FIG. 5g. Auditor D types in the regular price of $1.79 into regular price field 384, and the loyalty price of $1.59 into loyalty price field 386. Parmesan 422 is part of a mix & match offer, so Auditor D selects mix & match from offer type selector drop-down 390.

With mix & match selected in offer type selector drop-down 390, fields 392-398 are reconfigured to allow entry of information pertinent to the mix and match deal. Field 392 allows entry of a number of products required to be purchased to receive the mix and match discount. Auditor D enters ten products as the number indicated on price tag 432. Field 394 allows entry of the amount of money saved if the mix and match discount is attained. Auditor D enters $5 as indicated on price tag 432. Field 398 allows entry of an expiration date for the offer. Auditor D types in Jul. 4, 2017, as indicated on price tag 432.

Auditor D can also type in any notes desired into note field 380 and information regarding the location of parmesan 422 into location field 382. In other embodiments, additional fields are available for data entry by Auditor D, e.g., expiration date of the actual product. When done, Auditor D clicks save button 406 to complete auditing of Grocer Q house brand parmesan cheese. Entered information is stored in central database 56. The updated information is accessible by managers of retailer 50 through mission control website 100.

Auditors in the field will commonly enter a price wrong into the auditing app. A price might be entered wrong due to the auditor finding the correct product that has inadvertently been moved over the wrong price tag. In other cases, an auditor simply looks at the wrong price tag, enters the regular price as the sale price, or accidentally transposes two digits of the price. Incorrect auditing is a costly problem for retailers who depend on the competitive pricing intelligence to set prices. To limit the problem of wrong prices being entered, service provider 52 performs real-time checks to determine if the price is likely to be correct. Various signals and methods are used by service provider 52 to determine an expected price for a product. Service provider 52 reverse engineers the pricing strategy and price optimization systems of retailers to predict the expected price of an item. An expected price can be based on past prices for the same product at the same or similarly situated retailers, and how particular retailers tend to price that category of products in that geographical area. Service provider 52 understands what categories are historically discounted by particular retailers in particular geographic locations to drive traffic, and which categories of products are depended upon by the retailer to generate revenue. Service provider 52 looks at general tactical pricing rules used by retailers, such as the typical gap in price between store brands and private label brands, parity in price between different sizes of the same item, etc.

Once the pricing rules and strategies of a retailer are captured, the price of all items at that retailer can be accurately predicted. Service provider 52 determines whether each price entered by Auditor D fits within the known pricing strategies of the retailer. Prices outside of an expected range are flagged, and Auditor D is asked to verify or validate the price of the product. In one embodiment, service provider 52 calculates a standard deviation for the expected price of the product. Any price outside of two or three standard deviations of the expected price is flagged for verification by Auditor D. If a regular price looks like a promotional price, service provider 52 asks Auditor D whether the price is a promotional price. If a promotional price is expected, but the entered price does not appear to reflect the promotion, Auditor D is asked to look for the promotion and verify that no promotion is active for the product.

In FIG. 5h, Auditor D has entered a wrong price of $3.99 as the regular price of parmesan cheese 422. Auditor D apparently took the regular price from the Brand K pasta sauce inadvertently. Auditor D taps save button 406 to submit the prices to service provider 52 as part of the current mission. Service provider 52 compares the entered regular price of $3.99 against an expected price calculated for house brand parmesan cheese 422 and determines that $3.99 is unlikely to be the correct regular price for the parmesan.

Expected price can be calculated a plurality of ways. Service provider 52 may have historical data showing that the house brand parmesan in the current geographic region has always been priced between $1.59 and $2.29. Any price outside of the range $1.59-$2.29 is more than likely incorrect. In another embodiment, service provider 52 calculates a specific estimated price based on a historical average, a known price change at another local retailer, a change in cost of the manufacturer, or other pricing signals. Any price a certain percentage away from the expected price is considered likely to be incorrect. Alternatively, service provider 52 calculates a standard deviation and considers an entered price to be likely incorrect if the entered price is more than two or three standard deviations away from the expected price.

In FIG. 5i, based on the low likelihood that $3.99 is the proper price, service provider 52 generates a popup that asks Auditor D to verify that the $3.99 price is correct. Auditor D realizes that he or she has entered the wrong price and clicks “no” button 444 to return to the product page to enter a new price. In some cases, it might not be so obvious that Auditor D has accidentally typed the wrong price. If Auditor D maintains that $3.99 is the correct price by tapping “yes” button 442, the app prompts Auditor D to take a photograph of price tag 432, similar to the step shown in FIG. 5l. A manager can analyze the photograph and either confirm the price is correct or figure out what went wrong that caused Auditor D to record the wrong price.

In some cases, a retailer might price something outside of expected ranges. In FIG. 5j, price tag 450 indicates that Grocer Q has priced the 8-oz. parmesan product 422 at only $0.25 for loyalty members. FIG. 5k illustrates that Auditor D has entered the loyalty price of $0.25 into loyalty price field 386. Service provider 52 determines that a loyalty price of $0.25 is a lower loyalty price than expected, and generates a popup 456 asking Auditor D to validate the price. Auditor D double checks, and then clicks “yes” button 458 to indicate that $0.25 is indeed the correct loyalty price.

If after verifications, the price is still outside of an expected price range, e.g., outside three standard deviations of an expected price, Auditor D is prompted by service provider 52 through the app to enter a photograph of the product, and of any labelling or price tag on the shelf. FIG. 5l illustrates Auditor D taking a picture of price tag 450 with mobile phone 460 to prove that the $0.25 loyalty price is correct. The manager can later analyze the photograph to determine whether the correct price was ascertained. If a manager confirms through the photograph that the unexpected price is correct, the manager saves the price in service provider 52. Service provider 52 uses the feedback to update future price projections so that the pricing strategy used to estimate prices will consider the possibility of a $0.25 loyalty price for house brand parmesan.

Prompting Auditor D and providing real-time feedback on possible errors improves the accuracy of price auditing. Auditor D is prompted to verify incorrectly entered prices immediately while the auditor is still in the proximity of the product. Validating audited prices later, after the mission is complete, does not afford Auditor D the chance to correct prices because if the auditor has left the retailer the correct price is not easily ascertainable. Retailer 50 uses the accurate information about prices of products at competing retailers to set prices of products at locations of retailer 50. Retailer 50 is able to depend on the collected data because service provider 52 verifies prices with real-time feedback that prompts Auditor D to double-check prices.

FIGS. 5m-5n illustrate functionality of swap button 402. On the Grocer Q mission, Auditor D is presented with a Grocer M house brand chips product for auditing. Grocer Q does not sell Grocer M branded chips, but does have an equivalent Grocer Q house brand. Auditor D recognizes the issue and taps swap button 402 to indicate that a comparable product needs to be substituted for the Grocer M house brand. In FIG. 5n, Auditor D is presented with a popup 470 showing a list of substitutes 472 that a manager at retailer 50 has previously identified as acceptable substitutes. Substitutes can be alternatives within the same brand, e.g., wavy chips instead of flat cut chips or a different flavor of chip. Substitutes can also be different comparable brands. The substitute list in popup 470 includes a substitute product 472 that is a Grocer Q house brand. Auditor D taps the Grocer Q house brand chip substitute 472 on 474 to indicate that the Grocer Q brand will be submitted as a substitute for the Grocer M house brand.

If an acceptable substitute 472 is not listed on popup 470, Auditor D can tap submit button 474 to create a new substitute that is currently available at the retailer being audited. Auditor D submits a picture, a UPC, price, and any other required information to add the new substitute. In one embodiment, a manager must approve the new substitute through mission control website 100. In some embodiments, retailer 50 creates a mission request with the retailer 50 house brand for auditing at other retailers, and service provider 52 automatically displays the house brand of whichever retailer is being audited.

As used herein, the terms a product being audited, priced, price checked, shopped, comparison shopped, or price shopped are all equivalent terms meaning an auditor checking the price of a product.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of competitive shopping, comprising:
generating a list of products to be audited at a retailer;
transmitting the list of products to a mobile device of an auditor;
prompting the auditor to enter a price charged by the retailer for a product from the list of products using the mobile device;
comparing an entered price for the product to an expected price range for the product;
storing the entered price in a database if the entered price is within the expected price range; and
prompting the auditor to verify the entered price for the product if the entered price is not within the expected price range.

2. The method of claim 1, wherein generating the list of products to be audited includes optimizing the list of products to minimize a price uncertainty of a set of products larger than the list of products.

3. The method of claim 1, further including calculating the expected price range for the product based on a known pricing strategy of the retailer.

4. The method of claim 1, further including receiving a photograph from the auditor to verify the entered price for the product.

5. The method of claim 1, wherein prompting the auditor to enter the price for the product includes providing a possible location at the retailer where the product may be located.

6. The method of claim 1, further including storing a location of the product at the retailer when the auditor enters the price for the product.

7. The method of claim 6, further including ascertaining the location of the product using an electronic beacon or GPS device.

8. The method of claim 1, further including receiving the price of the product by optically scanning the product using the mobile device.

9. A method of competitive shopping, comprising:
prompting an auditor to enter a price of a product at a retailer;
comparing an entered price for the product to an expected price for the product;
storing the entered price in a computer database if the entered price is within an acceptable range of the expected price; and
prompting the auditor to verify the entered price for the product if the entered price is outside the acceptable range of the expected price.

10. The method of claim 9, further including calculating the expected price for the product based on a known pricing strategy of the retailer.

11. The method of claim 10, wherein the known pricing strategy includes an online price correlating with an in-store price.

12. The method of claim 9, further including receiving a photograph from the auditor to verify the entered price for the product.

13. The method of claim 9, further including storing a location of the product at the retailer when the auditor enters the price for the product.

14. The method of claim 13, further including ascertaining the location of the product using an electronic beacon or GPS device.

15. The method of claim 9, further including receiving the price of the product by optically scanning the product using a mobile device.

16. A method of competitive shopping, comprising:
providing a first set of products including a price associated with each of the products;
determining a priority for updating the price for each of the first set of products; and
generating a second set of products as a subset of the first set of products, wherein the second set of products includes the products with from the first set of products with the highest priority for updating.

17. The method of claim 16, wherein the priority for updating the price of each of the first set of products is determined based on a statistical price uncertainty of the products.

18. The method of claim 17, wherein the statistical price uncertainty of the products is proportional to an amount of time since the price associated with the product was ascertained.

19. The method of claim 16, further including reducing the priority for updating the price of a product when a price in-store for the product correlates with a price online with the product.

20. The method of claim 16, further including increasing the priority for updating the price of a product when an MSRP of the product changes.
